(19) United States
(12) Patent Application Publication
(10) Pub. No.: US 2025/0373372 A1
(43) Pub. Date: Dec. 4, 2025

(54) Traffic-Dependent Discarding and Data Throttling Mechanisms

(71) Applicant: Apple Inc., Cupertino, CA (US)

(72) Inventors: Ahmed M. SOLIMAN, Munich (DE); Ayman F. NAGUIB, Cupertino, CA (US); Danila ZAEV, Munich (DE); Kenza HAMIDOUCHE, Cupertino, CA (US); Mohamed KHALIL, Weyarn (DE)

(21) Appl. No.: 19/222,073

(22) Filed: May 29, 2025

Related U.S. Application Data
(60) Provisional application No. 63/654,299, filed on May 31, 2024.

(51) Int. Cl. H04L 1/20

(52) U.S. Cl. CPC H04L 1/203

(57) ABSTRACT

An apparatus configured to generate a set of representations for a data flow, wherein each representation comprises one or more blocks, wherein each block of the set of blocks has an assigned weight, generate a set of protocol data units (PDUs) corresponding to the set of representations, wherein each PDU comprises a weight based on the assigned weight of blocks in each PDU, determine a weighted packet error rate for the set of PDUs and select a number of PDUs of the set of PDUs to discard, wherein a combined weight of the number of PDUs is less than the weighted packet error rate.

### PRIORITY/INCORPORATION BY REFERENCE

This application claims priority to U.S. Provisional Application Ser. No. 63/654,299 filed on May 31, 2024, entitled “Traffic-Dependent Discarding and Data Throttling Mechanisms,” the entirety of which is incorporated by reference herein.

### BACKGROUND

Wireless communication systems are rapidly growing in usage and constantly evolving. It is anticipated that future evolutions of the cellular standards, e.g., (3GPP standards) may include aspects of semantic communication. Some goals of semantic communication may be to provide optimized Quality of Service (Qos) for data flows. Part of providing data flows may include discarding some data to throttle data flows during high traffic periods. However, there are inconsistencies between throttling data flows and providing a desired Qos for the data flows.

### SUMMARY

Some example embodiments are related to an apparatus having processing circuitry coupled to memory, wherein the processing circuitry is configured to generate a set of representations for a data flow, wherein each representation comprises one or more blocks, wherein each block of the set of blocks has an assigned weight, generate a set of protocol data units (PDUs) corresponding to the set of representations, wherein each PDU comprises a weight based on the assigned weight of blocks in each PDU, determine a weighted packet error rate for the set of PDUs and select a number of PDUs of the set of PDUs to discard, wherein a combined weight of the number of PDUs is less than the weighted packet error rate.

Other example embodiments are related to an apparatus having processing circuitry coupled to memory, wherein the processing circuitry is configured to generate a set of representations for a data flow, wherein each representation comprises one or more blocks, generate a set of protocol data units (PDUs) corresponding to the set of representations, determine an interdependency for each of the one or more blocks, determine a PDU associated with a first block has been discarded and discard one or more additional PDUs associated with blocks that have an interdependency with the first block.

Still further example embodiments are related to an apparatus having processing circuitry coupled to memory, wherein the processing circuitry is configured to generate a plurality of sub-flows comprising a plurality of packets in each sub-flow, wherein each packet comprises a packet identification (ID), a sub-flow ID identifying one of the plurality of sub-flows to which the packet belongs, and a group ID identifying a group within the one of the plurality of sub-flows to which the packet belongs and determine, for each sub-flow, a packet error rate threshold.

### BRIEF DESCRIPTION OF THE DRAWINGS

FIG. 1 shows an example network arrangement according to various example embodiments.

FIG. 2 shows an example user equipment (UE) according to various example embodiments.

FIG. 3 shows an example base station according to various example embodiments.

FIG. 4 shows an example hierarchical protocol data unit (PDU) structure for semantic communications according to various example embodiments.

FIG. 5 shows an example data flow having a hierarchical PDU structure according to various example embodiments.

FIG. 6 shows an example PDU according to various example embodiments.

FIG. 7 shows an example of block interdependencies according to various example embodiments.

### DETAILED DESCRIPTION

The example embodiments may be further understood with reference to the following description and the related appended drawings, wherein like elements are provided with the same reference numerals. The example embodiments relate to various aspects of semantic communication. Specifically, the example embodiments relate to discarding data and data throttling.

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate type of electronic component.

The example embodiments are also described with regard to a sixth generation (6G) network. However, reference to a 6G network is merely provided for illustrative purposes. The example embodiments may be utilized with any appropriate type of network and that supports semantic communications as described herein, including future evolutions of the cellular standards beyond 6G.

The example embodiments are related to semantic communications. Semantic communications differ from traditional or classic communications. Specifically, traditional communication modes use error-free deterministic communications, e.g., the data that is to be transmitted by a transmitter and received by a receiver is the actual data that is to be exchanged, e.g., data that represents pixel values of an image. In contrast, semantic communications are not limited to transmission of the actual data. Rather, semantic communications transmit semantic representations of the data, e.g., semantic data or metadata about the data that is to be transmitted. The receiver may use this semantic data or metadata to reconstruct the actual data that the transmitter intends without the transmitter sending the actual data.

One advantage of semantic communications is that the semantic representations of data, e.g., semantic data or metadata about the data to be transmitted, may be smaller than the actual data to be transmitted. To provide an example, the semantic representation of an image may be significantly smaller than the actual data of the image. This reduction in the amount of data required to exchange information between a transmitter and receiver may allow for higher throughputs to accommodate heavy traffic scenarios.

Semantic communications is not data compression. That is, traditional communication modes may use various compression algorithms to compress the size of the actual data, e.g., there are multiple forms of MPEG compression that reduce the size of video files for traditional communications. These forms of compression typically remove some of the actual data from the data being transmitted and the receiver may decode the compressed data using interpolation or other methods. Semantic communications are different from compression (or encoding) because the reduced amount of data used for semantic communications is not a subset of the actual data as in traditional communication compression.

To provide a very simple example of transmitting an image that includes a tree. Traditional communication modes need to represent each pixel of the image that includes the tree and transmit those representations of each pixel to the receiver. The receiver may decode the representations of each pixel and display the image. In contrast, in semantic communications, the semantic representation may be as simple as indicating a ‘tree.’ The receiver may then place a tree in the image. The semantic representation may be more complicated, e.g., ‘a tree with green leaves’, ‘a tree with fall color leaves’, ‘an oak tree’, etc. From this simple example, it can be seen that the amount of data used to convey the same information is significantly less using semantic communications.

In a communication system, there may be scenarios where a transmitter of data may have to throttle data flows, e.g., when there is congestion on a network. Throttling data flows may include dropping some protocol data units (PDUs) to decrease a number of PDUs that the transmitter is sending. However, dropping PDUs of a data flow may affect the quality of the data flow at the receiving end.

The example embodiments describe different aspects for discarding PDUs of a packet flow. In some aspects, PDUs may be discarded based on a weight of the PDUs and a preconfigured error threshold. In other aspects, PDUs may be discarded based on interdependencies with other PDUs. These different discarding techniques may be used independently, in combination with the other aspects or with other discarding techniques.

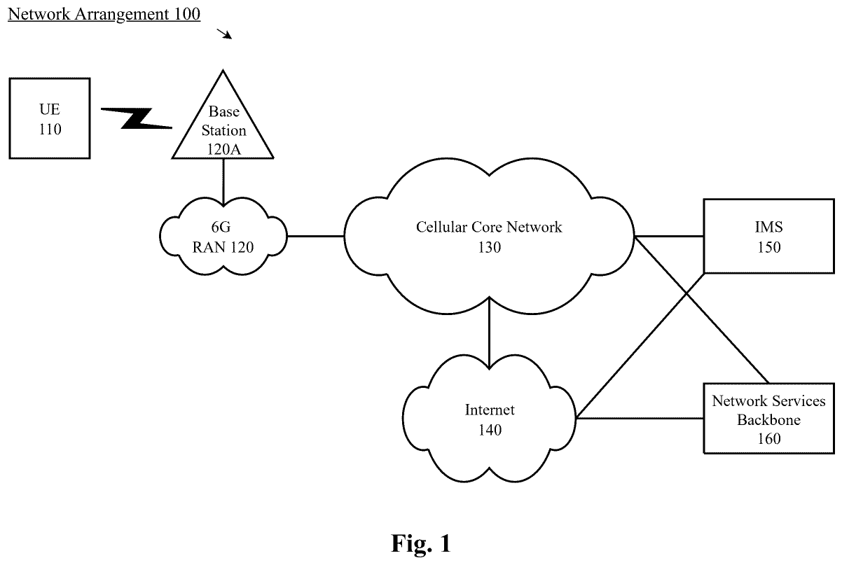

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, phablets, embedded devices, wearables, Internet of Things (IoT) devices, etc. An actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 6G radio access network (RAN) 120. However, the UE 110 may also communicate with other types of networks (e.g., fifth generation (5G) RAN, 5G cloud RAN, a next generation RAN (NG-RAN), a long-term evolution (LTE) RAN, a legacy cellular network, a wireless local area network (WLAN), etc.) and the UE 110 may also communicate with networks over a wired connection. With regard to the example embodiments, the UE 110 may establish a connection with the 6G RAN 120. Therefore, the UE 110 may have at least a 6G chipset to communicate with the 6G RAN 120.

The 6G RAN 120 may be a portion of a cellular network that may be deployed by a network carrier (e.g., Verizon, AT&T, T-Mobile, etc.). The 6G RAN 120 may include base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Any association procedure may be performed for the UE 110 to connect to the 6G RAN 120. For example, as discussed above, the 6G RAN 120 may be associated with a particular cellular provider where the UE 110 and/or the user thereof has a contract and credential information (e.g., stored on a SIM card). Upon detecting the presence of the 6G RAN 120, the UE 110 may transmit the corresponding credential information to associate with the 6G RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer to an interconnected set of components that manages the operation and traffic of the cellular network. It may include the evolved packet core (EPC), the 5G core (5GC), the 6G core (6GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

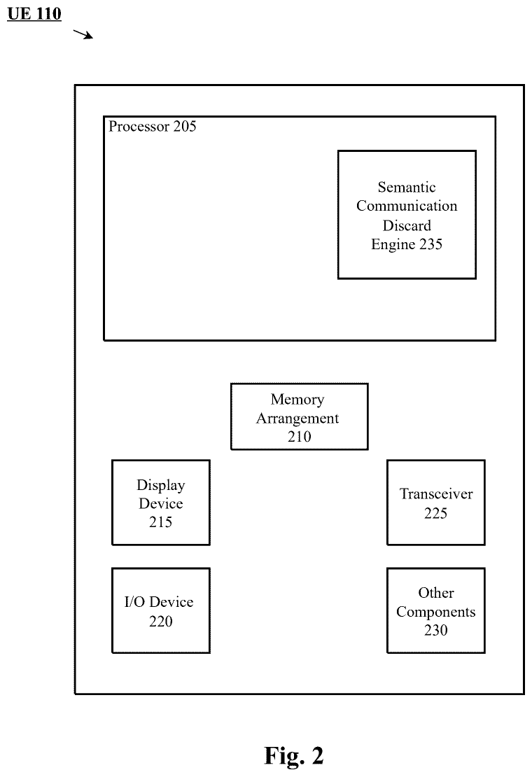

FIG. 2 shows an example UE 110 according to various example embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a semantic communication discard engine 235. The semantic communication discard engine 235 may perform various operations related to discarding PDUs of semantic communications. To provide some general examples, the semantic communication discard engine 235 may perform operations such as, but not limited to, semantic encoding of input data, determining semantic sub-flows for the semantic data, determining a weight of semantic PDUs or sub-flows, determining a packet error rate, determining interdependencies of PDUs or sub-flows and determining PDUs to discard based on the weight, packet error rate and/or interdependencies. Each of these example operations will be described in greater detail below.

The above referenced engine 235 being an application (e.g., a program) executed by the processor 205 are merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. In particular, in some examples, it is the capabilities of the UE 110 typically handled by the baseband processor that may be reduced when the UE 110 is operating in the low battery mode. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 6G-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode, decode and/or process signals (e.g., signaling from a base station of a network) for implementing any one of the methods described herein.

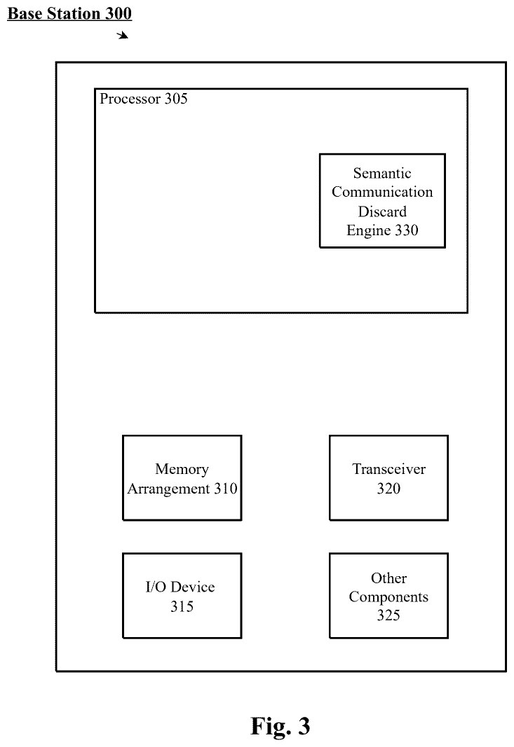

FIG. 3 shows an example base station 300 according to various example embodiments. The base station 300 may represent any base included within the network, e.g., base station 120A.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, TxRUs, transceiver chains, antenna elements, antenna panels, etc.

The processor 305 may be configured to execute a plurality of engines for the base station 300. For example, the engines may include a semantic communication engine 330. The semantic communication discard engine 330 may perform various operations for the base station 300 related to related to discarding PDUs of semantic communications. These example operations will be described in greater detail below.

The above noted engine 330 being an application (e.g., a program) executed by the processor 305 is only an example. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some servers, the functionality described for the processor 305 is split among a plurality of processors (e.g., a baseband processor, an applications processor, etc.). In particular, in some examples, it is the operations for communicating with the UE 110 that are typically handled by the baseband processor that may be reduced when the UE 110 is operating in the low battery mode. The example embodiments may be implemented in any of these or other configurations of a server.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UEs in the network arrangement 100.

The transceiver 320 may operate on a variety of different frequencies or channels (e.g., set of consecutive frequencies). Therefore, the transceiver 320 may include one or more components to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

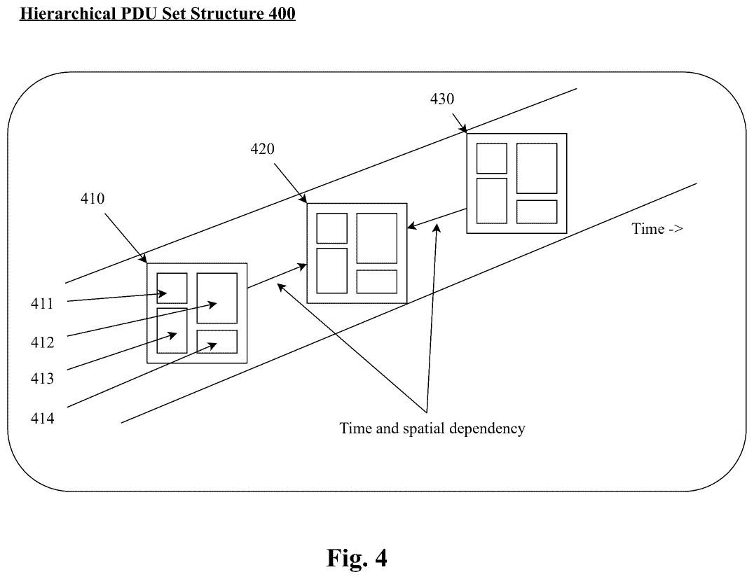

FIG. 4 shows an example hierarchical protocol data unit (PDU) structure 400 for semantic communications according to various example embodiments. The hierarchical PDU structure 400 may include representations 410-430 of any type of data flow, e.g., images, video frames, audio frames, etc. As shown in FIG. 4, the different representations 410-430 may have time and spatial dependencies upon each other.

Within each representation 410-430, there may be blocks of data, e.g., image segments, video frame segments/slices, audio segments, etc.). For example, representation 410 may include blocks 411-414. These blocks 411-414 may also have dependencies.

Thus, if data traffic is to be throttled by discarding some PDUs, and representations and/or blocks have dependencies, discarding a PDU for one representation/block may have consequences for other representations/blocks. The example embodiments introduce a traffic dependent discarding mechanisms to insure that PDUs are discarded in a manner that does not affect the quality of the data at a receiving end.

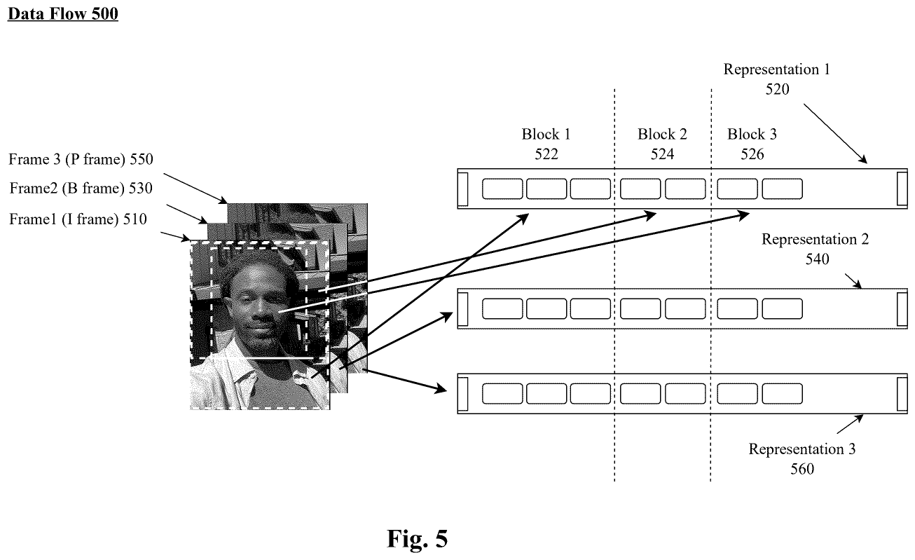

FIG. 5 shows an example data flow 500 having a hierarchical PDU structure according to various example embodiments. In the example of FIG. 5, the data flow 500 may be a video data flow comprising I, P and B frames. However, this is only an example and the example embodiments may be applied to other types of data flows.

In this example, there are three video frames, Frame 1 510 (an I frame), Frame 2 530 (a B frame) and Frame 3 550 (a P frame). Each frame 510-530 is represented by a corresponding representation, e.g., Frame 1 510 corresponding to representation 520, Frame 2 530 corresponding to representation 540, and Frame 3 550 corresponding to representation 560. Each representation 520, 540, 560 has blocks representing data of the corresponding frame. For example, representation 520 of the frame 510 may include a block 1 522, a block 2 524 and a block 3 526. Each of the blocks 522-526 may have data associated with the frame 510. Similarly, the representations 540 and 560 may have blocks having data for the frames 530 and 550, respectively.

In the example embodiments, each PDU within a representation may have a defined weight in constructing the final message (e.g., video frame). When all PDUs of a representation are successfully transmitted, this means 100% of the required weights are correctly delivered and the receiver may reconstruct the message with full quality. For example, if a receiver receives all the PDUs of the representation 1 520, the receiver may reconstruct the Frame 1 510.

However, when only a certain percentage (e.g., 70%) of PDUs of a representation are successfully transmitted, this may not mean that 70% of the required weights are correctly delivered as the successfully delivered aggregate weight depends on the weight of the delivered PDUs. For example, if the 70% of the PDUS represent a weight below a threshold, the receiver may not be able to reconstruct the message with full quality.

In the example embodiments, a UE (e.g., in the uplink (UL) and/or a network (e.g., a base station in the downlink (DL) may consider the weight of the PDUs to be discarded to discard the highest number of PDUs when needed, e.g., in a congestion scenario, with the lowest impact on the aggregate weight and quality. In the example embodiments, an Error Rate (e.g., Packet Error Rate (PER)) may not define the upper bound for the number of PDU losses but may define an upper bound for the aggregate weights of PDU losses.

For example, a representation (e.g., representation 520) may comprise K blocks indexed by k∈{1, . . . , K}. For each block k, the total number of packets Nₖ in the block, and the total weight wₖ of the block may be provided in the configuration of the representation. Thus, the total representation weight may be computed as:

$$W := {\sum }_{k = 1}^{K} {w}_{k}$$

In some example embodiments, W=1 and, thus, this operation may not be performed.

If Sₖ is the number of successfully received packets from block k. The weighted packet error rate may be determined as:

$$WPER := 1 - \frac{1}{W} {\sum }_{k = 1}^{K} ( \frac{{S}_{k}}{{N}_{k}} \cdot {w}_{k} )$$

The criterion for the successful delivery may be defined as WPER≤Th, where Th is the percentage of the required weight to be delivered.

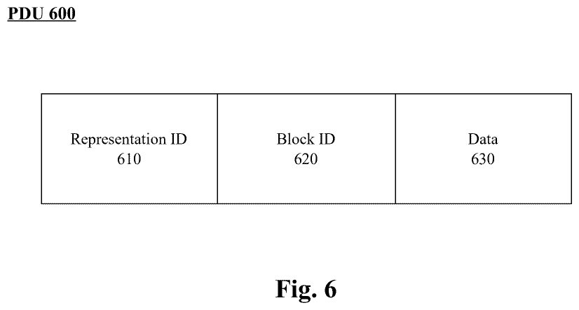

Each PDU may be marked with a Representation ID and a Block ID. FIG. 6 shows an example PDU 600 according to various example embodiments. The example PDU 600 may have a Representation ID 610, a Block ID 620 and may also include data 630.

In the UL, a Package Data Convergence Protocol (PDCP) layer of a UE may insert the Representation ID 610 and the Block ID 620 into the PDU 600. The PDCP layer may receive this information directly from an upper layer.

In the DL, a Use Plane Function (UPF) of a core network may insert this information into the PDU 600. The UPF may determine this information from a Traffic Dependent-Communication Optimization (TDCO) header. The TDCO header may include various data related to the representation, including but not limited to, data type values, data type length values, data sensitivity, data importance 840, etc. This information may also include the Representation ID 610 and the Block ID 620.

Thus, in a discard scenario, (e.g., a congestion scenario), the transmitter (e.g., base station in the DL or UE in the UL, may determine to reduce the amount of transmitted data by limiting the data to be transmitted to the minimum level. Therefore, the base station or UE may be selective and discard the packets with lowest weight.

For example, assume the PER for a representation (e.g., representation 520) is 30%. This means the base station or UE should guarantee that at least 70% of the representation weights should be successfully delivered or, conversely, 30% of the representation weights may be discarded. To continue with the example of representation 520, it may be considered that the block 1 522 PDUs have the highest weight, the block 2 524 PDUs have less weight and the block 3 526 PDUs have the lowest weight. Therefore, the transmitter may decide to discard more packets from block 3 526 (e.g., the lowest weighted block) to be able to discard more packets with minimum impact on the aggregate weight.

Thus, in the example embodiments, the use of the multi-dimensional data representation approach (e.g., representation, block), the transmitter may discard based on the PDU weights instead of just discarding a certain number of PDUs.

However, as described above, in addition to weights, blocks may also have interdependencies, e.g., each block may depend on one or more other blocks in the same representation or in different representations. Dependency may be a separate aspect that may not be linked to the weight. This may allow more flexibility when deciding discarding operations, (e.g., a lower weight block may depend on a higher weight block and vice versa).

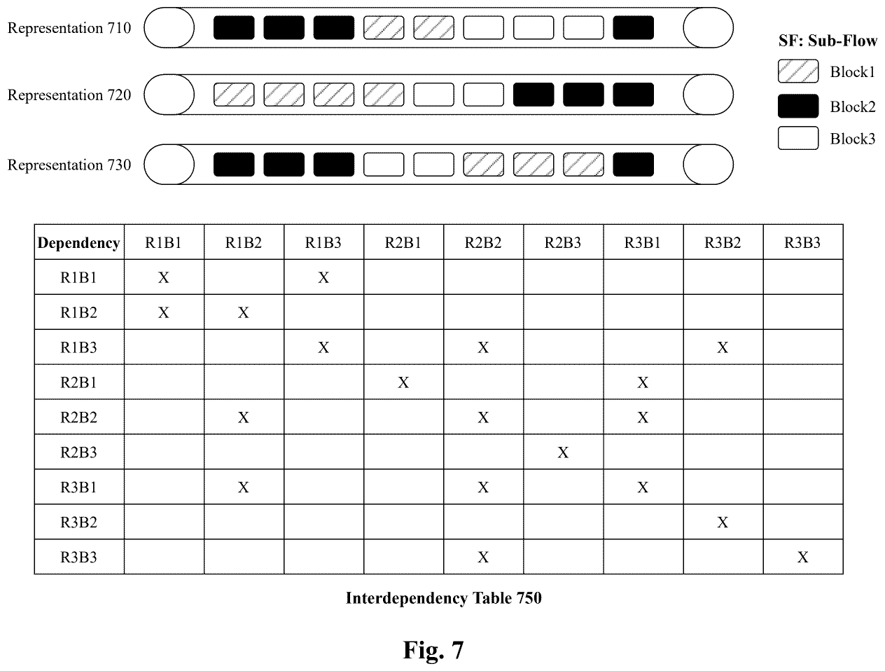

FIG. 7 shows an example of block interdependencies according to various example embodiments. In the example of FIG. 7, there are three representations, representation 710, representation 720 and representation 730. Each representation 710-730 has various blocks as shown in the figure. Each block may be representative of a particular sub-flow of the data flow.

An interdependency table 750 shows the interdependencies between the different blocks. For example, the top row and the left column list each of the blocks in the format RXBY, where RX is a representation and BY is a block in the representation, e.g., R1B1 represents representation 1 (710) block 1. The X's in the boxes of the interdependency table 750 shows the other blocks on which a block depends. For example, the block R2B2, depends on the blocks R1B2, R2B2 (itself) and R3B1.

An application function (AF) of a core network may provide a network exposure function (NEF) or policy control function (PCF) with interdependency assistance information, e.g., the interdependency table 750. The PCF may provide a session management function (SMF) with policy and charging control (PCC) rules considering the interdependency information received from the AF. The SMF may configure the UPF and a base station/UE with an interdependency configuration based on the PCC rules received from the PCF.

Thus, a base station in the DL or a UE in the UL may determine to discard a specific block when it depends on another discarded/lost block.

In some example embodiments, the data flow is divided into one or more sub-flows. An example of this is shown in FIG. 7, wherein each block of a representation represents a different sub-flow, e.g., Block 1 of the representations 710-730 represents a first sub-flow, Block 2 of the representations 710-730 represents a second sub-flow, etc.

In these example embodiments, the PDUs may include a packet identification (ID), a sub-flow ID identifying one of the plurality of sub-flows to which the PDU belongs, and/or a group ID identifying a group within the sub-flows to which the PDU belongs.

In the discarding example embodiments described above, a packet error rate threshold was determined. This may be extended such that a packet error rate for each of the sub-flows may be determined. If the packet error rate of one of the sub-flow exceeds the packet error rate threshold, the PDUs of this sub-flow may be discarded.

The packet error rate thresholds for the different sub-flows may be the same as other sub-flows or different from other sub-flows.

A period for determining the packet error rate for the sub-flows may be preconfigured. In addition, after the PDUs of a sub-flow have been discarded, a time to resume transmission of the sub-flow may be preconfigured.

In addition, similar to the interdependency examples described above, there may be interdependencies among sub-flows such that PDUs of a first sub-flow that are interdependent with PDUs of a second sub-flow that has been discarded, may also be discarded.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as ios, Android, etc. The example embodiments described above may be embodied as a program containing lines of code stored on a non-transitory computer readable storage medium that, when compiled, may be executed on a processor or microprocessor.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAS.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

As described above, one aspect of the present technology is the gathering and use of data available from specific and legitimate sources to improve the delivery to users of invitational content or any other content that may be of interest to them. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to deliver targeted content that may be of greater interest to the user in accordance with their preferences. Accordingly, use of such personal information data enables users to have greater control of the delivered content.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, such as in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely block the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus comprising processing circuitry coupled to memory, wherein the processing circuitry is configured to:
generate a set of representations for a data flow, wherein each representation comprises one or more blocks, wherein each block of the set of blocks has an assigned weight;
generate a set of protocol data units (PDUs) corresponding to the set of representations, wherein each PDU comprises a weight based on the assigned weight of blocks in each PDU;
determine a weighted packet error rate for the set of PDUs; and
select a number of PDUs of the set of PDUs to discard, wherein a combined weight of the number of PDUs is less than the weighted packet error rate.

2. The apparatus of claim 1, wherein the PDUs to be discarded are selected based on the weight of each of the PDUs.

3. The apparatus of claim 2, wherein the PDUs to be discarded are PDUs associated with blocks having a lowest weight.

4. The apparatus of claim 1, wherein each PDU comprises a representation identification (ID) identifying a representation of the set of representations with which the PDU is associated.

5. The apparatus of claim 1, wherein each PDU comprises a block identification (ID) identifying a block of the one or more blocks with which the PDU is associated.

6. The apparatus of claim 1, wherein the processing circuitry is further configured to:
generate, for transmission, one or more messages comprising a subset of the PDUs from the set of PDUs, wherein the subset does not include the PDUs to be discarded.

7. The apparatus of claim 6, wherein the one or messages are transmitted in an uplink (UL).

8. The apparatus of claim 6, wherein the one or messages are transmitted in a downlink (DL).

9. The apparatus of claim 1, wherein the data flow comprises an image, a video frame, or an audio frame.

10. The apparatus of claim 1, wherein the each of the one or more blocks are associated with a sub-flow of the data flow.

11. An apparatus comprising processing circuitry coupled to memory, wherein the processing circuitry is configured to:
generate a set of representations for a data flow, wherein each representation comprises one or more blocks;
generate a set of protocol data units (PDUs) corresponding to the set of representations;
determine an interdependency for each of the one or more blocks;
determine a PDU associated with a first block has been discarded; and
discard one or more additional PDUs associated with blocks that have an interdependency with the first block.

12. The apparatus of claim 11, wherein the interdependency for each block comprises an interdependency with a block in a same representation or a block in a different representation.

13. The apparatus of claim 11, wherein the data flow comprises an image, a video frame, or an audio frame.

14. The apparatus of claim 11, wherein the each of the one or more blocks are associated with a sub-flow of the data flow.

15. An apparatus comprising processing circuitry coupled to memory, wherein the processing circuitry is configured to:
generate a plurality of sub-flows comprising a plurality of packets in each sub-flow, wherein each packet comprises a packet identification (ID), a sub-flow ID identifying one of the plurality of sub-flows to which the packet belongs, and a group ID identifying a group within the one of the plurality of sub-flows to which the packet belongs; and
determine, for each sub-flow, a packet error rate threshold.

16. The apparatus of claim 15, wherein the processing circuitry is further configured to:
determine a packet error rate of one of the sub-flows;
when the packet error rate of the one of the sub-flow exceeds the packet error rate threshold of the one of the sub-flows, discard packets of the sub-flow.

17. The apparatus of claim 16, wherein each sub-flow has a different packet error rate threshold.

18. The apparatus of claim 16, wherein a period of determining the packet error rate for the one of the sub-flows and a time to resume transmission of the one of the sub-flows is preconfigured.

19. The apparatus of claim 15, wherein the processing circuitry is further configured to:
select a number of packets from one of the sub-flows to discard, wherein the number of packets to be discarded results in a packet error rate that is less than the packet error rate threshold of the one of the sub-flows.

20. The apparatus of claim 15, wherein the processing circuitry is further configured to:
determine a first group ID of a first sub-flow has an interdependency on a second group ID of a second sub-flow;
determine packets having the first group ID of the first sub-flow have been discarded;
discard packets having the second group ID of the second sub-flow based on the interdependency.
